(19) United States
(12) Patent Application Publication
(10) Pub. No.: US 2026/0320173 A1
(43) Pub. Date: Oct. 15, 2026

(54) MACHINE-LEARNING BASED METHOD FOR PERFORMING AI SECURITY ANALYSIS BASED ON EXECUTING CODE IN A VIRTUAL ENVIRONMENT

(71) Applicants: Constructor Technology AG, Schaffhausen (CH); Constructor Education and Research Genossenschaft, Schaffhausen (CH)

(72) Inventors: Alexander Tormasov, Bremen (DE); Ivan Tsyganov, Neuchatel (CH); Kevin Reed, Singapore (SG); Laurent Dedenis, Geneve (CH); Stanislav Protasov, Singapore (SG); Serg Bell, Singapore (SG); Nikolay Dobrovolskiy, Alanya (TR)

(21) Appl. No.: 19/177,737

(22) Filed: Apr. 14, 2025

(51) Int. Cl. G06F 21/53; G06F 11/34; G06F 21/56

(52) U.S. Cl. CPC G06F 21/53; G06F 11/3409; G06F 21/566; G06F 2221/033

(57) ABSTRACT

Disclosed herein are systems and methods for analyzing safety of software code associated with scientific or technical documents during execution of the software code in a pre-configured virtual environment. The method includes: executing the software code in the pre-configured virtual environment; monitoring computational resources and/or data sources utilized by the software code during execution, and collecting an execution log of the software code; performing a passive real-time performance analysis of the software code to detect deviations from predicted utilization of computational resource and/or data sources; and when deviations are detected, halting execution of the software code and performing a performance analysis and malware analysis of the execution log and/or a plurality of temporary files created during code execution for suspicious malicious behavior; and determining whether it is safe to continue executing the software code based on the passive real-time performance analysis and/or the performance analysis and malware analysis

### FIELD OF TECHNOLOGY

The present disclosure relates to the field of machine learning, and, more specifically, to systems and methods for machine-learning based methods for performing artificial intelligence (AI) security analysis by executing software code in a pre-configured virtual environment.

### BACKGROUND

In the academic and scientific circles, published scientific or technical documents often include software code that executes or simulates experiments or computations described in the document. However, hackers can introduce viruses and backdoor vulnerabilities into this software code or completely replace the original code with a malicious one. As an example, a piece of malware could be embedded within dead code branches or hidden in an algorithm that mimics legitimate computations. By exploiting weaknesses in code validation processes, hackers can introduce vulnerabilities that enable remote access, data theft, or system corruption, making it crucial to refine benchmarking and similarity checks to detect and prevent such security threats. In this way, discrepancies between predicted and actual resource utilization during code execution could indicate unauthorized operations, such as hidden data exfiltration or unauthorized network access. As an example, if a scientific article describes calculation of solar flares, but the software code associated with that article collects passwords, then the software code should be flagged as malicious or suspicious.

### SUMMARY

To perform security analysis on complex computational models attached to scientific or technical documents, the present disclosure describes executing software code in a pre-configured virtual environment in order to monitor resources and/or data sources utilized by the software code during execution for detecting deviations from predicted utilization of computational resources and/or data sources. If deviations are detected, then the present disclosure describes halting the software code and performing active static performance and malware analysis of the execution log to identify suspicious malicious behavior. Accordingly, the present disclosure describes determining whether it is safe to continue to execute the software code based on both the passive real-time performance and/or the static performance and malware analysis.

In one exemplary aspect, a method for analyzing safety of software code associated with scientific or technical documents during execution of the software code is disclosed. The method includes: executing the software code in a pre-configured virtual environment; monitoring computational resource and/or data sources utilized by the software code during execution, and collecting an execution log of the software code; performing a passive real-time performance analysis of the software code to detect deviations from predicted utilization of computational resource and/or data sources; and when deviations are detected, halting execution of the software code and performing a performance analysis and malware analysis of the execution log and/or a plurality of temporary files created during code execution for suspicious malicious behavior; and determining whether it is safe to continue executing the software code based on the passive real-time performance analysis and/or the performance and malware analysis.

In some aspects, the techniques described herein relate to a method, further comprising setting up the pre-configured virtual environment by analyzing the software code and/or associated scientific or technical document using one or more prepared machine learning models (MLM) to predict computational resources and/or data sources to be utilized during execution of the software code, and configuring the virtual environment before execution of the software code based on the predicted utilization of the computational resources and/or data sources.

In some aspects, the techniques described herein relate to a method, further comprising: performing the performance analysis using a prepared MLM trained on a plurality of scientific or technical documents to understand contents of the plurality of temporary files.

In some aspects, the techniques described herein relate to a method, further comprising: performing the malware analysis using a prepared MLM trained on a plurality of known malicious behavior patterns and/or malware signatures.

In some aspects, the techniques described herein relate to a method, further comprising: based on a determination that the software code is safe, reconfiguring the virtual environment based on detected deviations in utilized computational resources and/or data sources; and continuing executing the software code in the re-configured virtual environment.

In some aspects, the techniques described herein relate to a method, wherein computational resources include one or more of: processor utilization, memory utilization, number of computational iterations, duration of the computation, and/or network utilization.

In some aspects, the techniques described herein relate to a method, wherein the deviations include at least one of: accessing external redate sources, accessing forbidden system resources, changing OS kernel parameters, and/or utilizing more or less computational or network resources than predicted.

In some aspects, the techniques described herein relate to a method, further comprising: preparing a first MLM to analyze the software code to predict computational parameters based on the software code by: (1) providing, to the first MLM, an analysis training dataset comprising at least: (a) a code training dataset comprising at least source code and metadata corresponding to features for the source code to extract patterns that predict computational parameters, (b) a computational parameter training dataset comprising at least data requirement information and execution configuration information to provide ground truth labels for computational parameters required for execution, (c) a code-document interaction training dataset comprising at least annotations, mapping rules, and execution example logs to provide additional context about how the software code was executed, and (d) ground truth labels for the code training dataset, the computational parameter training dataset, and the code-document interaction training dataset to serve as a target output for the first MLM; and (2) preparing the first MLM using the analysis training dataset.

In some aspects, the techniques described herein relate to a method, further comprising: preparing a second MLM to analyze the scientific or technical documents to predict computational parameters based on the scientific or technical documents and known computational parameters of a similar scientific or technical document by: (1) providing, to the second MLM, a document analysis training dataset comprising at least: (a) a training documents dataset comprising at least text of training documents and metadata to enable similarity analysis and prediction, wherein the training documents dataset is labeled and annotated to identify a subject matter to group documents, (b) a code training dataset comprising at least source code associated with the training documents and metadata corresponding to features of source code to capture features from code associated with the training documents to provide execution context, (c) a computational parameter training dataset comprising at least execution settings and execution logs to provide ground truth labels for computational parameters required for execution, (d) a similarity training dataset comprising at least document similarity pairs, code similarity pairs, and cross-mapping data to establish relationships between documents based on similarity and associated execution parameters, (e) ground truth labels for the training documents dataset, the code training dataset, the computational parameter training dataset, and the similarity training dataset to serve as a target output for the second MLM; and (2) preparing the second MLM using the document analysis training dataset.

In some aspects, the techniques described herein relate to a method, wherein the performance analysis comprises any one of an active static analysis, execution artifact analysis, and/or symbolic execution.

According to one aspect of the disclosure, a system is provided for analyzing safety of software code associated with scientific or technical documents during execution of the software code, the system including: at least one memory; and at least one hardware processor coupled with the at least one memory and configured, individually or in combination, to: execute the software code in a pre-configured virtual environment; monitor computational resource and/or data sources utilized by the software code during execution, and collecting an execution log of the software code; perform a passive real-time performance analysis of the software code to detect deviations from predicted utilization of computational resource and/or data sources; and when deviations are detected, halting execution of the software code and perform a performance analysis and malware analysis of the execution log and/or a plurality of temporary files created during code execution for suspicious malicious behavior; and determine whether it is safe to continue executing the software code based on the passive real-time performance analysis and/or performance analysis and malware analysis.

In one exemplary aspect, a non-transitory computer-readable medium is provided storing a set of instructions thereon for analyzing safety of software code associated with scientific or technical documents during execution of the software code, the system, including instructions for: executing the software code in a pre-configured virtual environment; monitoring computational resource and/or data sources utilized by the software code during execution, and collecting an execution log of the software code; performing a passive real-time performance analysis of the software code to detect deviations from predicted utilization of computational resource and/or data sources; and when deviations are detected, halting execution of the software code and performing a performance analysis and malware analysis of the execution log and/or a plurality of temporary files created during code execution for suspicious malicious behavior; and determining whether it is safe to continue executing the software code based on the passive real-time performance analysis and/or the performance analysis and malware analysis.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for analyzing safety of software code associated with scientific or technical documents during execution of the software code in a virtual environment according to aspects of the present disclosure.

FIG. 2 is a block diagram illustrating a system for preparing machine learning models to analyze safety of software code associated with scientific or technical documents according to aspects of the present disclosure.

FIG. 3 is an example flowchart for performing an analysis of software code associated with a scientific or technical document during execution of the software code in a pre-configured virtual environment according to aspects of the present disclosure.

FIG. 4 is an example method for analyzing safety of software code associated with scientific or technical documents during execution of the software code according to an aspect of the present disclosure.

FIG. 5 resents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for analyzing safety of software code associated with scientific or technical documents without executing the software code. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

High-performance computing (HPC) environments are essential for executing complex computational tasks, such as simulating planetary movements, predicting weather patterns, or analyzing genetic modifications. The HPC environment is a specialized computing system designed to process complex and resource-intensive tasks by leveraging parallel processing, clustered computing architectures, and high-speed networking. These HPC environments of multiple interconnected processors (CPUs or GPUs) that work together to execute large-scale computations efficiently, often running specialized software and job schedulers to manage workloads. HPC systems are widely used in scientific research, engineering, bioinformatics, financial modeling, and artificial intelligence, enabling tasks such as climate modeling, genetic sequencing, and deep learning training. By providing massive computational power, HPC environments allow researchers and organizations to solve intricate problems faster than traditional computing systems, optimizing performance for simulations, data analysis, and machine learning applications. Their scalability and efficiency make them crucial for advancing technology and scientific discovery. However, these computations often require extensive processing power and may run for weeks or months to complete execution.

In addition, malware can infiltrate large-scale computations in HPC environments through compromised code, malicious scripts, or unauthorized access to temporary files and execution logs. Given the complexity and scale of HPC workloads, malware can remain undetected while manipulating computational results, exfiltrating sensitive data, or consuming excessive resources to disrupt operations. Attackers may embed malware in scientific simulations, financial models, or AI training processes, leading to inaccurate results, security breaches, or system failures. Detecting and mitigating such threats requires continuous monitoring, anomaly detection, and active performance analysis to ensure computational integrity and prevent unauthorized exploitation of HPC resources.

Conventional methods for ensuring the integrity and security of software code during execution in HPC environments rely on a combination of access controls, runtime monitoring, and anomaly detection. For example, job schedulers and workload managers enforce user authentication and resource allocation policies to prevent unauthorized code execution. Runtime monitoring tools track CPU and memory usage, system calls, and network activity to detect unexpected deviations that may indicate inefficiencies or potential security threats. Static and dynamic code analysis are used to examine code before and during execution, ensuring it adheres to expected computational behaviors. Additionally, sandboxing and virtualization isolate code execution to limit potential damage from malicious or inefficient processes. While these methods provide a baseline for security and performance assurance, they may not fully detect sophisticated malware or performance anomalies, necessitating more advanced machine learning-based analysis and active performance monitoring techniques.

To address these issues, the present disclosure considers the potential deviation between predicted and actual computational loads when determining whether software code is malicious or inefficient. Before execution, the system predicts the expected computational resources based on known computational resources from similar research articles. However, if real execution deviates significantly—such as excessive CPU and RAM usage—it may indicate inefficient code, misconfigured environments, or, worse, malicious activity. Detecting these deviations early is crucial to optimizing resource allocation and preventing unnecessary costs. Another significant challenge is ensuring that code execution is not compromised by malware or other security threats. In some cases, the expected computational results may be replaced with suspicious or unexpected data, such as stolen passwords or unauthorized files. This raises concerns about whether the code should continue running or be terminated to prevent potential security breaches.

A first aspect of the present disclosure describes executing the code in a virtual environment such as a HPC cluster and then implementing a multi-stage analysis using passive static performance analysis and active static performance analysis. A second aspect of the present disclosure describes detecting suspicious code by detecting deviations of real computational parameters from predicted computational parameters generated using a machine learning model (MLM). A third aspect of the present disclosure describes halting the execution of code in the virtual environment and performing active static performance analysis and/or malware analysis in the virtual environment based on a determination that the detected deviations exceed certain thresholds. In this way, the present disclosure can determine whether the software code should continue to execute (e.g., software is deemed safe) or to terminate the software code (e.g., software is deemed unsafe)

The technical benefits of the present disclosure of performing a two-tiered passive real-time analysis and a performance analysis (e.g., any one of a combination of active static analysis, execution artifacts analysis and/or symbolic execution) on software code executed in a HPC environment include at least enhanced computational efficiency and security. By analyzing temporary files, execution logs, and system parameters while the software code is halted (e.g., suspended), the present disclosure enables early detection of anomalies, such as excessive resource usage, suspicious data patterns, or unauthorized access. This proactive approach helps in identifying malware that may be embedded in computational workloads, preventing potential data breaches or system disruptions. Additionally, by comparing real-time computational parameters against predicted values derived from MLM-based article analysis, the system can automatically detect inefficiencies or misconfigurations in the virtual environment. For example, if deviations between the real-time computational parameters and the predicted computational parameters exceed a threshold, the system can intelligently decide whether to terminate execution, optimize resource allocation, or initiate deeper performance and security analysis. This ensures that scientific simulations, AI model training, and other large-scale computations run efficiently while maintaining system integrity, reducing computational waste, and mitigating cybersecurity risks.

Ultimately, the present disclosure aims to establish a more reliable method for validating software code against scientific research in a safe and controlled virtual environment, ensuring that computational resources are accurately predicted, and potential security risks are identified early. By refining similarity criteria, enhancing benchmarking accuracy, and incorporating human feedback into the evaluation process, the system can improve its confidence in determining whether code is safe and corresponds to its intended scientific application.

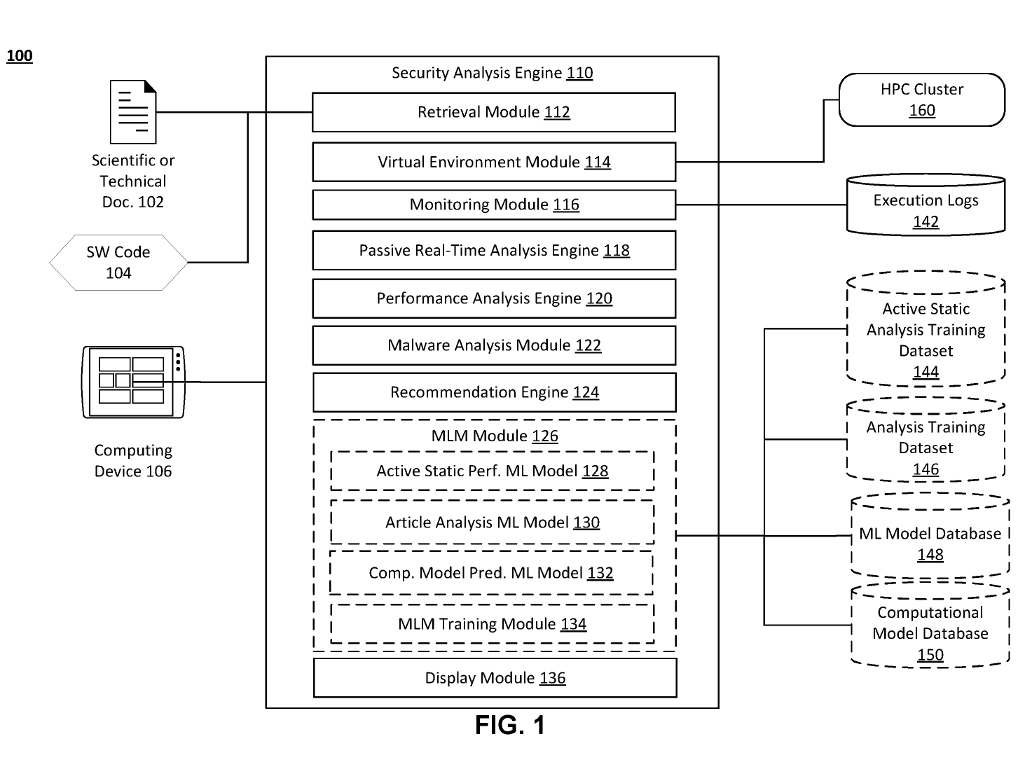

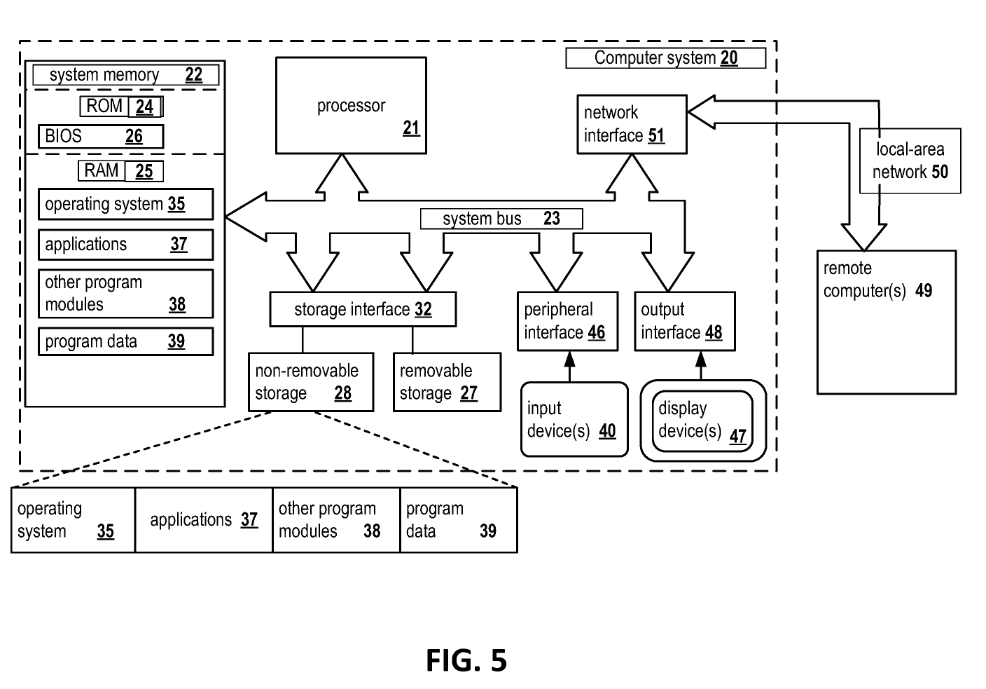

FIG. 1 is a block diagram illustrating a system for analyzing safety of software code associated with scientific or technical documents during execution of the software code in a virtual environment. In one aspect, the components of system 100 may be implemented on computer systems, such as that shown in FIG. 5.

The system 100 may be used to perform security analysis of software code by executing software code in a configured virtual environment based on detecting suspicious activity. Specifically, the security analysis engine 110 is configured to monitor the execution environment by performing a passive real-time online analysis to detect deviations from predicted and real computational loads and parameters. If a deviation exceeds a particular threshold, then the security analysis engine 110 performs a performance analysis of the executing environment including analyzing temporary files created during code execution and data stored to determine whether those files contain personal user data or other sensitive or privileged information that should not be accessed or collected by the software code. In this way, the security analysis engine 110 can determine whether software code executed in a HPC cluster 160 is malicious or safe based on evaluating outputs from both the active static performance and the passive real-time online analysis.

A HPC cluster 160 is a network of interconnected computers that work together to perform complex computations at high speed. It distributes workloads across multiple processors, enabling parallel processing for tasks such as scientific simulations, data analysis, and machine learning. HPC clusters use specialized hardware, optimized networking, and resource management systems to maximize efficiency. They can also integrate virtual environments, such as containers or VMs, to enhance software portability and execution consistency. By leveraging massive computational power, HPC clusters accelerate processing times and support advanced research and industrial applications.

The system 100 includes at least a scientific or technical document 102, a software code 104 corresponding to the scientific or technical document 102, a computing device 106, a security analysis engine 110, and various databases (e.g., execution log 142, an optional active static analysis training dataset 144, an optional analysis training dataset 146, an optional ML database 148, a computational model database 150, and a HPC cluster 160. The security analysis engine 110 is configured to conducts security analysis of software code executed in the HPC cluster 160 by passively monitoring execution for deviations in computational parameters and, if a threshold is exceeded, performing a performance analysis to detect unauthorized access to sensitive data, determining if the code is malicious or safe. The computing device 106 may execute a plurality of modules in the security analysis engine 110 that together make up the collection, analysis, prediction, and determination system. In some aspects, the security analysis engine 110 may correspond to the computing device 106 or cloud network (not shown) that is configured to execute a plurality of modules that make up the security analysis engine 110.

In some aspects, the security analysis engine 110 may include a retrieval module 112, a virtual environment module 114, a monitoring module 116, a passive real-time analysis engine 118, a performance analysis engine 120, a malware analysis module 122, a recommendation engine 124, an optional MLM module 126 including at least an optional active static performance MLM 128, an optional article analysis MLM 130, an optional computation model prediction MLM 132, and a MLM training module 134, and a display module 136. In some aspects, the training data for the MLM training module 134 may be obtained from the optional active static analysis training dataset 144, the optional analysis training dataset 146, and/or the computational model database 150. In some aspects, the optional active static performance MLM 128, the optional article analysis MLM 130, and/or the optional computational model prediction 132 may be stored on the MLM database 148.

In some aspects, the computing device 106 may execute a retrieval module 112 configured to retrieve the scientific or technical document 102 and the software code 104 associated with the scientific or technical document 102. The software code 104 may include executable code and/or source code. In some aspects, the retrieval module 112 may access the MLM model database 148 and/or the computational model database 150. In some aspects, the retrieval module 112 may access the scientific or technical document 102 and the associated software code 104 from the internet or any other suitable sources.

In some aspects, the computing device 106 may execute a virtual environment module 114 configured to connect to the HPC cluster 160 by dynamically allocating resources and configuring an optimized execution environment based on the predicted computational load. The virtual environment module 114 may interface with the HPC cluster 160 through APIs, job schedulers like SLURM or Kubernetes, or direct SSH connections to provision CPUs, GPUs, memory, and storage as needed. To ensure software isolation and dependency management, the virtual environment module 114 deploys virtual environments using containers such as Docker or Singularity, or virtual machines (VMs). Once configured, the virtual environment module 114 may distribute the software execution across multiple HPC nodes using parallel computing frameworks like MPI or Open MP, optimizing workload distribution to enhance performance.

In some aspects, the computing device 106 may execute a virtual environment generation module 114 configured to generate a suitable and secure computing virtual environment configured to execute the software code 104 (e.g., C++, Python, MATLAB, etc.) corresponding to a scientific or technical document 102. In some aspects, the virtual environment generation module 114 may provide a cloud-based container to compare research articles to the code in the articles. In some examples, the virtual environment generation module 114 may provide a virtual machine, a container, a docket container, and/or a sandbox to execute research articles to the code in the articles.

In some aspects, the computing device 106 may execute a monitoring module 116 configured to track computational resources and data sources utilized by the software code 104 during execution in the virtual environment or HPC cluster 160, ensuring efficient resource management and security compliance. The monitoring module 116 may continuously monitor and log CPU, GPU, memory, and storage usage in the execution log 142, as well as network activity, to detect deviations from expected computational loads. Additionally, the monitoring module 116 tracks data sources accessed by the software code 104, including temporary files, databases, and external APIs, to identify any unauthorized access or anomalies. The monitoring module 116 collects a comprehensive execution log 142 that records system events, process activities, and resource consumption throughout the software’s runtime. This execution log 142 provides valuable insights for performance analysis, debugging, and security auditing. If any irregularities or suspicious behaviors are detected, the monitoring module 116 can trigger alerts or initiate corrective actions, ensuring that the execution remains within defined operational parameters.

In some aspects, the computing device 106 may execute a passive real-time analysis engine 118 is configured to perform continuous monitoring of software execution by analyzing real-time computational resource usage and data access patterns. The passive real-time analysis engine 118 passively observes the behavior of the software code 104 without interfering with execution. In particular, the passive real-time analysis engine 118 may be configured to compare actual resource utilization (e.g., including CPU, GPU, memory, storage, and network activity) to predicted computational loads. Additionally, the passive real-time analysis engine 118 tracks data sources accessed during execution to detect deviations from expected patterns, such as unauthorized file access or excessive data retrieval. By leveraging statistical models and machine learning algorithms, the passive real-time analysis engine 118 identifies anomalies that may indicate inefficiencies, security risks, or potential malicious activity. If a deviation exceeds predefined thresholds, the passive real-time analysis engine 118 can flag the anomaly for further investigation or trigger additional security measures, ensuring that the software operates within safe and expected parameters.

In some aspects, the computing device 106 may execute a performance analysis engine 120 to perform a performance analysis (e.g., one of or a combination of an active static analysis, execution artifact’s analysis and/or symbolic execution) by analyzing the execution environment of the software code 104 while the software code 104 is halted. This may involve detecting and evaluating temporary files that are generated during code execution to identify whether they contain sensitive or privileged information that should not be accessed or collected. The performance analysis engine 120 operates by intercepting file system activities, tracking the creation, modification, and deletion of temporary files, and inspecting their contents for indicators of sensitive data such as personally identifiable information (PII), authentication credentials, or confidential system data. Through advanced pattern recognition, heuristic analysis, and data classification techniques, the performance analysis engine 120 cross-references extracted data with predefined security policies and compliance standards to determine potential risks. If unauthorized access or improper storage of sensitive data is detected, the performance analysis engine 120 generates alerts, logs security violations, and provides remediation guidance to prevent data leakage. By actively analyzing temporary file usage in real time, the performance analysis engine 120 enhances security by mitigating risks associated with improper data handling while ensuring compliance with privacy regulations and industry best practices.

In some aspects, the computing device 106 may execute a malware analysis module 122 configured to perform malware analysis by examining the execution log 142 and analyzing a plurality of temporary files generated during code execution for indications of suspicious or malicious behavior. The malware analysis module 122 systematically inspects execution logs to identify anomalies such as unauthorized system calls, unexpected network activity, or deviations from normal execution patterns that may indicate malware activity. Simultaneously, malware analysis module 122 monitors temporary file creation, modification, and deletion to detect embedded malicious payloads, obfuscated scripts, or unauthorized data exfiltration attempts. Using signature-based detection, heuristic analysis, and behavioral monitoring techniques, the malware analysis module 122 correlates suspicious activities across execution logs and temporary file contents to uncover hidden threats, including trojans, keyloggers, or ransomware. If malicious behavior is detected, the malware analysis module 122 generates alerts, quarantines infected files, and provides forensic data to security teams for further investigation.

In some aspects, the computing device 106 may execute a recommendation engine 124 configured to assess the safety of continuing software execution by analyzing insights gathered from passive real-time performance analysis, active static performance analysis, and/or malware analysis. This recommendation engine 124 continuously evaluates execution behavior, system resource utilization, and security threats to detect anomalies or potential risks. By leveraging passive real-time analysis, the recommendation engine 124 monitors the software’s runtime characteristics, such as CPU and memory consumption, response times, and deviations from expected performance patterns, to identify inefficiencies or potential stability issues. Simultaneously, the recommendation engine 124 incorporates findings from active static performance analysis, which examines temporary files and execution logs for sensitive data exposure or security violations, ensuring compliance with data protection policies. Additionally, the recommendation engine 124 integrates malware analysis results to detect signs of malicious activity, unauthorized system access, or code tampering. Based on a comprehensive assessment of these factors, the recommendation engine 124 decides whether execution should proceed, be halted, or require remediation. If a threat or performance issue is identified, the recommendation engine 124 may trigger alerts, enforce security policies, or initiate automated countermeasures to mitigate risks, ensuring safe and reliable software operation.

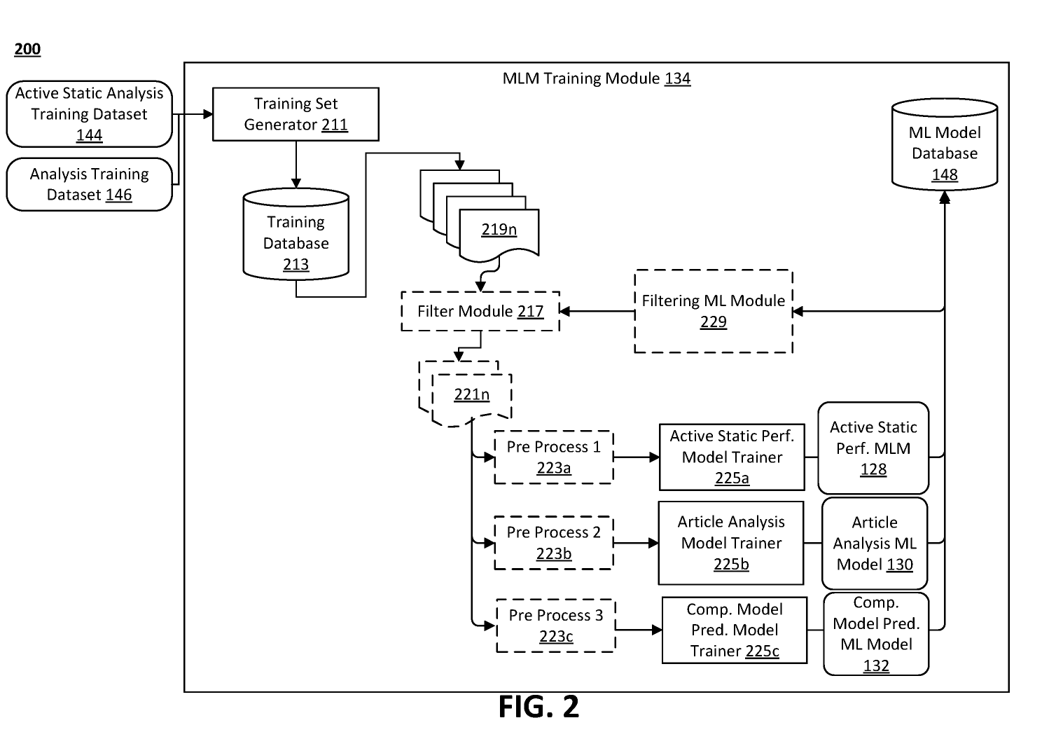

In some aspects, the computing device 106 may execute an optional MLM module 126 including an optional active static performance MLM 128, an optional article analysis MLM 130, an optional computational model prediction MLM 132, and/or a MLM training module 134. The optional active static performance MLM 128 is configured to perform the active static performance analysis on a plurality of scientific or technical documents to understand contents of the temporary files. The optional article analysis MLM 130 is configured to predict a computational model based on the scientific or technical document 102 and a known computational model of a similar scientific or technical document from the computational model database 150. The optional computational model prediction MLM 132 is configured to predict a computational model based on the software code 104 such that the first computational model indicates computational resources and/or data sources utilized for execution of the software code 104. As will be described in more detail with respect FIG. 2, the optional MLM training module 126 is configured to train an optional active static performance MLM 128, an optional article analysis MLM 130, and/or an optional computational model prediction MLM 132 and may contain specifically trained MLMs. For illustrative purposes, the present disclosure will describe the MLM as an LLM, but those of ordinary skill in the industry will recognize that any suitable type of MLM may be utilized in the present disclosure.

A LLM is a type of AI designed to understand and generate human language. LLMs are trained on vast amounts of text data, enabling it to perform a wide range of language-related tasks such as answering questions, summarizing text, translating languages, or generating content. LLMS, similar to generative pretrained transformer (GPT), use deep learning techniques to recognize patterns, learn context, and predict word sequences making them highly versatile in natural language processing applications. Accordingly, the computing device 106 may execute the optional MLM training module 126 to train the LLMs in the optional active static performance MLM 128, the optional article analysis MLM 130, and/or the optional computation model prediction MLM 132 to teach the MLMs to perform their respective specific tasks. Further details about the training of each respective MLM will be described in further detail in FIG. 2.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are GPT and Bidirectional Encoder Representations from Transformers (BERT).

The optional active static performance MLM 128 is configured to perform active static performance analysis by leveraging machine learning techniques to analyze temporary files generated during code execution. The active static performance MLM 128 is trained on a vast corpus of scientific and technical documents from the optional active static analysis training dataset 144, enabling it to develop a deep understanding of various file structures, data formats, and contextual indicators of sensitive or performance-impacting information. By applying natural language processing (NLP) and pattern recognition techniques, the active static performance MLM 128 can intelligently interpret the contents of temporary files to determine whether they contain personally identifiable information (PII), authentication credentials, encryption keys, or other privileged data that should not be stored, accessed, or transmitted by the executing code.

The training process of the optional active static performance MLM 128 involves supervised and unsupervised learning approaches, where the optional active static performance MLM 128 is exposed to large datasets containing labeled examples of benign and sensitive data patterns. It learns to differentiate between normal system-generated temporary files and those that may introduce security risks or performance inefficiencies. Additionally, the optional active static performance MLM 128 is designed to identify anomalous data storage behaviors, such as excessive logging, redundant file creation, or improper handling of confidential information, which could degrade system performance or violate data protection policies.

While the software cold is halted, the optional active static performance MLM 128 monitors and evaluates temporary files. In this case, halting refers to suspension of the software code in the pre-configured virtual environment rather than a complete termination of the code execution. This distinction is important because it allows the system to pause operations temporarily while retaining the ability to resume execution if conditions are deemed satisfactory. The optional active static performance MLM 128 applies its learned representations to classify file contents, detect potential security threats, and assess compliance with industry regulations. If the optional active static performance MLM 128 identifies any risks, it can trigger the recommendation engine 124 to perform automated remediation steps, such as alerting security teams, blocking access to sensitive files, or optimizing resource allocation to enhance system efficiency.

For analysis tasks such as analyzing the scientific or technical document 102, an unprepared article analysis MLM 130 will first analyze data from an optional article training dataset (not pictured) and/or a document analysis training dataset to “learn” how to find similar scientific or technical document from the previously analyzed articles database (not pictured) in order to predict a computational model based on the contents of the scientific or technical document 102. The process may begin with analyzing the scientific or technical document 102 alongside a known computational model derived from a similar document. This may involves extracting relevant features such as structural patterns, referenced computational methodologies, and dependencies within the document. The optional article analysis MLM 130 is then trained to recognize correlations between these features and the computational resources and data sources utilized in the known model using an analysis training dataset 146.

By leveraging supervised or semi-supervised learning techniques, the optional article analysis MLM 130 learns to generalize patterns that map document content to computational execution requirements. Once trained, the optional article analysis MLM 130 can predict the computational resources and data sources necessary for executing software code associated with the scientific or technical document 102, thereby facilitating the automation of computational model generation for new technical documents.

During training of the optional article analysis MLM 130, the results from the untrained MLM are then compared with known data set results using the corresponding ground truth labels for a document analysis training dataset, a code training dataset, and a computational parameter training dataset. It should be noted that the input to the trained/prepared article analysis MLM 130 will be data from the analysis training dataset 146. As an example, the analysis training dataset 146 may include at least: (a) a training documents dataset comprising at least text of training documents and metadata to enable similarity analysis and prediction, wherein the training documents dataset is labeled and annotated to identify a subject matter to group documents, (b) a code training dataset comprising at least source code associated with the training documents and metadata corresponding to features of source code to capture features from code associated with the training documents to provide execution context, (c) a computational parameter training dataset comprising at least execution settings and execution logs to provide ground truth labels for computational parameters required for execution, (d) a similarity training dataset comprising at least document similarity pairs, code similarity pairs, and cross-mapping data to establish relationships between documents based on similarity and associated execution parameters, and (e) ground truth labels for the training documents dataset, the code training dataset, the computational parameter training dataset.

For every input training sample from the analysis training dataset 146, the prepared article analysis MLM 130 will produce a prediction consisting of values representing a probability that computational resources and/or data sources utilized for execution of the software code 104 is accurate with respect to a known computational model from the computational model database 150. The output with the highest probability determines the identification. A class label for each answer may be used to compute a loss (e.g., loss function).

The trained article analysis MLM 130 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the MLM is trained (e.g., inference), the trained article analysis MLM 130 may predict a computational model for executing software code associated with the scientific or technical document 102 based on a known computational model for a previously analyzed scientific or technical paper that is similar to the scientific or technical document 102.

During inference, the trained article analysis MLM 130 does not re-evaluate or adjust the layers of the neural network based on the results. Instead, the inference applies knowledge from the trained neural network and uses it to infer a result. Accordingly, when a new unknown dataset (e.g., unknown scientific or technical paper) is input through the trained article analysis MLM 130, the trained MLM outputs a predicted computational model for the scientific or technical document 102 based on the predictive accuracy of the MLM.

Similarly, during preparation (e.g., training) of the optional computation model prediction MLM 132 to predict a computational model based on the software code 104, the process also involves analyzing the structure, dependencies, and execution patterns of the software code 104. The optional computation model prediction MLM 132 is trained on labeled datasets containing code samples mapped to their corresponding computational resources and data sources used during execution. Feature extraction techniques, such as static and dynamic code analysis, are employed to identify function calls, libraries, memory usage, and data flow patterns. By learning these correlations, the optional computation model prediction MLM 132 can predict the computational resources and data sources required for executing new software code, enabling efficient resource allocation and execution planning.

The analysis training dataset 146 for the optional computation model prediction MLM 132 may include at least: (a) a code training dataset comprising at least source code and metadata corresponding to features for the source code to extract patterns that predict computational parameters, (b) a computational parameter training dataset comprising at least data requirement information and execution configuration information to provide ground truth labels for computational parameters required for execution, (c) a code-document interaction training dataset comprising at least annotations, mapping rules, and execution example logs to provide additional context about how the software code was executed, and (d) ground truth labels for the code training dataset, the computational parameter training dataset, and the code-document interaction training dataset to serve as a target output for the optional computation model prediction MLM 132.

In some aspects, the optional computation model prediction MLM 132 may be trained based on a public training dataset such as GitHub repositories. The process begins with data collection, where large-scale open-source codebases are extracted, including metadata on computational resources (e.g., CPU, GPU usage) and data sources (e.g., APIs, databases) referenced in execution. Feature extraction techniques, such as tokenization, abstract syntax tree (AST) analysis, and embedding models like CodeBERT, are applied to represent the software code in a structured manner. The optional computation model prediction MLM 132 is then trained using supervised learning, where labeled examples of software code and their corresponding computational models serve as training pairs. Techniques such as sequence-to-sequence models, graph neural networks (GNNs), or transformer-based architectures are employed to learn patterns in how computational resources and data sources are utilized. The model is fine-tuned through loss optimization and validation against a test set to improve prediction accuracy. Once trained, the computational model prediction MLM 130 can analyze new software code and predict the associated computational model, enabling automated resource estimation, optimization, and efficient deployment planning.

For every input training sample from the analysis training dataset 146, the prepared optional computation model prediction MLM 132 may produce a prediction consisting of values representing a probability that a computational resource and/or data source to be utilized when executing the software code 104 is identified based on the software code 104. The output with the highest probability determines the predicted computational model for the software code 104.

In some aspects, an optimizer such as Adam or SGD may be used to train the models in the optional active static performance MLM 128, the optional article analysis MLM 130, and/or the optional computational model prediction MLM 132. In some aspects, the data may be split into training, validation, and test sets. In these aspects, optional active static performance MLM 128, the optional article analysis MLM 130 and/or the optional computational model prediction MLM 132 are trained on the training dataset and then validated by the validation sets to tune hyperparameters.

The computing device 106 may execute the display module 136 to generate and display the results of the passive real-time performance analysis, the active static performance, malware analysis, and/or safety recommendation of the software code 104. Generally, the display module 136 is responsible for managing and rendering the visual components of the user interface by handling the presentation of information to the user, ensuring that data and controls are displayed correctly and consistently across the UI.

In some aspects, the display module 136 is configured to render or draw all the elements of the UI, such as windows, buttons, text fields, menus, icons, images, and other components. In some aspects, the display module 136 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 136 may be considered the “view” part of a model-view-controller (MVC) or similar design pattern. It serves as the layer that presents data to the user and receives input to and from the computing device 106.

It should be noted that the analysis, generation, and comparison of the predicted and actual computational models and/or parameters are heavily simplified. One skilled in the art will appreciate that the engines and/or MLMs utilized may have significantly large datasets with highly specific details due to the complexity and scale of modern software systems. Computational models involve numerous interdependent factors, such as memory allocation, processing power, parallel execution, I/O operations, and external data dependencies, all of which require intricate calculations and cross-referencing vast amounts of technical details. Human cognition is limited in its ability to manually track and analyze these dependencies with the precision and efficiency required for accurate predictions. Furthermore, software code often includes dynamic execution behaviors, runtime optimizations, and external API interactions that cannot be fully anticipated without automated analysis. Machine learning models excel in recognizing patterns, processing large datasets, and making data-driven predictions, enabling them to analyze software code efficiently and generate reliable computational models in a way that manual methods simply cannot achieve within a reasonable timeframe.

FIG. 2 is a block diagram illustrating a system for analyzing safety of software code associated with scientific or technical documents while executing the software code in a safe environment according to aspects of the present disclosure. As shown in example 200, the MLM training module 134 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled training data sets, the specialized machine learning models may perform particular tasks such as predicting a first computational model based on software code and predict a second computational model based on a known computational model for a document similar to the scientific or technical document.

Supervised learning is effective for tasks such as classification (assigning inputs to predefined categories) and regression (predicting continuous values) since it relies on the availability of labeled data for both training and evaluation phases. In supervised learning, the MLM training module 134 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 134 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 134 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 134 includes at least a training database 213 configured to store the raw training data 219n and corresponding labels, a MLM database 148 to store the trained models (e.g., the prepared active static performance MLM 128, the prepared active analysis MLM 130, and/or the optional computational model prediction MLM 132). In some aspects, the MLM training module 134 may include an optional filtering ML module 229 and an optional filter module 217 configured to filter data from the training database 213 for training by removing poorly generated training data.

Training data from an active static analysis training dataset 144 and an analysis training dataset 146 is received into the MLM training module 134 via the training set generator 211. Details about the data included in each training dataset is described in more detail above with FIG. 1.

An optional filtering ML module 229 is configured to filter out bad training data to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a, optional preprocess 2223b, and the optional preprocess 223c are automated processes that modify the raw data received from 219n (or cleaned training dataset 221n) and prepare the raw data as input to the respective model trainers (e.g., active static performance trainer 225a, article analysis model trainer 225b, the computational model prediction model trainer 225c). These may be described in the MLM training module 134 as snippets of code that prepares the datasets. In some examples, the preprocessing module (e.g., preprocess 1 223a, preprocess 2 223b, preprocess 223c) for a particular trainer may be an automated script or code that will be set up the first time any model is trained.

The active static performance model trainer 225a, article analysis model trainer 225b, and/or the computational model prediction model trainer 225c are the scripts or code that train the respective models. The active static performance model trainer 225a, article analysis model trainer 225b, and/or the computational model prediction model trainer 225c may be a script or code that holds the instructions on how a model should be trained (e.g., optimization method, model architecture, dataset division, etc.) and also runs the training. The active static performance model trainer 225a, article analysis model trainer 225b, and/or the computational model prediction model trainer 225c each take as input the raw or filtered processed training data and train the active static performance model trainer 225a, article analysis model trainer 225b, and/or the computational model prediction model trainer 225c to achieve their specific objectives, respectively.

In summary, the raw dataset 219n or cleaned dataset 221n may optionally go through different preprocessing steps 223a, 223b, 223c and then a corresponding active static performance model trainer 225a, article analysis model trainer 225b, and/or the computational model prediction model trainer 225c to generate a prepared active static performance MLM 128, a prepared article analysis MLM 130, and a prepared optional computation model prediction MLM 132. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training data from the training database 213. Accordingly, to create a clean and filtered training dataset, the optional filter module 217 is configured to filter out unwanted data points from the raw training dataset 219n by developing smaller, less accurate systems based on patterns and metadata information.

During the training process, the active static performance model trainer 225a, article analysis model trainer 225b, and the computational model prediction model trainer 225c are presented with input data and labels of actual values, and the optimization objective, which aims to minimize the difference between the actual value and the predicted value, is calculated. The optimization algorithm updates the parameters of the active static performance model trainer 225a, article analysis model trainer 225b, and the computational model prediction model trainer 225c to reduce the value of the objective. This process is repeated for several iterations until the parameters do not change anymore. This process is repeated for various combinations of hyperparameters, and the model with the smallest label prediction error is selected as the final model.

When a new model (e.g., the prepared active static performance MLM 128, the prepared article analysis MLM 130, and the prepared optional computation model prediction MLM 132) is created, and a new process for filtering and automated labeling is established, it is added to the MLM database 148 in the MLM training module 134. This enables the new model to be part of the closed-loop model update process. Optionally, at regular intervals, data which is continuously collected can be filtered, labeled, and used to update old models by an optional filtering ML module 229. In some examples, the optional filtering ML module 229 is a neural network. In some examples, the optional filtering ML module 229 is a mathematical model. This approach may capture changes in the data over time.

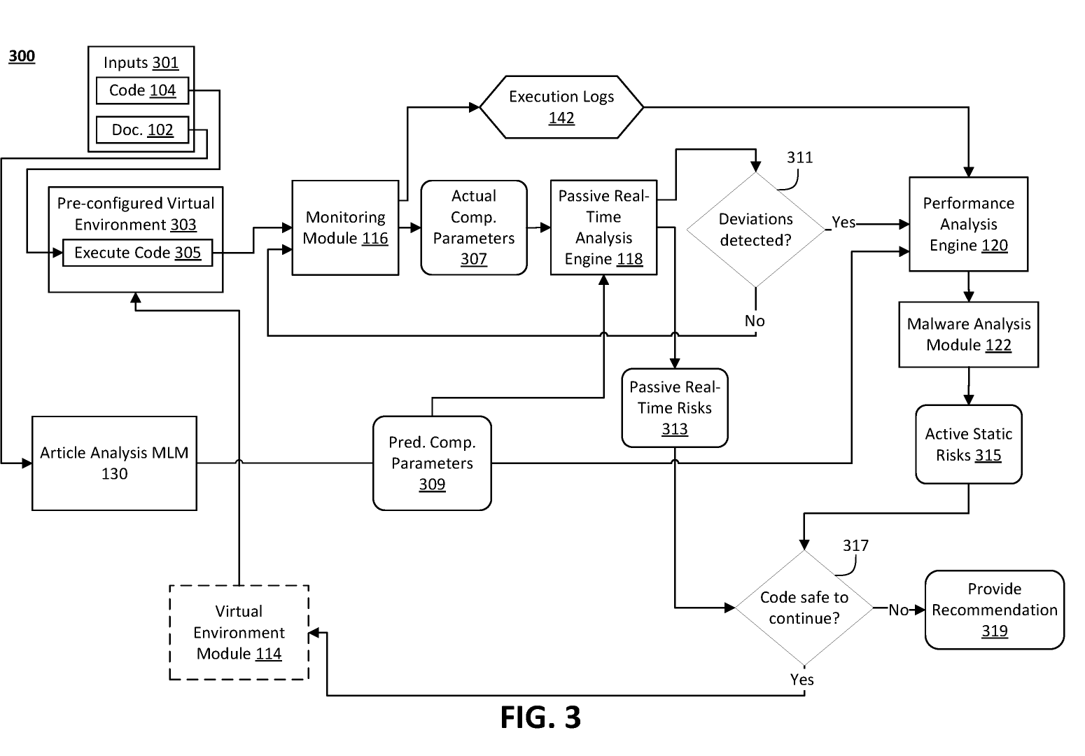

FIG. 3 is an example flowchart performing an analysis of software code associated with a scientific or technical document during execution of the software code in a pre-configured virtual environment according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes a method of performing an analysis of software code associated with a scientific or technical document during execution of the software code in a preconfigured computing environment.

The method 300 begins obtaining a scientific or technical document 102 and software code 104 associated with the scientific or technical document 102 (collectively, the inputs 301). Many scientific or technical documents may rely on software code for data analysis, simulations, or computational models. By providing the software code, researchers ensure that other can replicate their results.

The method 300 facilitates the execution 305 of software code 104 within a pre-configured virtual environment 303 or an HPC cluster (e.g., HPC cluster 160 from FIG. 1) to ensure safety, optimal performance and resource management. By leveraging a virtual environment, the software code 104 runs in a controlled and isolated setting, eliminating dependencies on external configurations and enhancing reproducibility. Alternatively, executing the software on an HPC cluster enables parallel processing, distributing computational tasks across multiple nodes to accelerate execution. This approach is particularly useful for complex simulations, large-scale data processing, and machine learning workloads, where computational efficiency and scalability are critical.

The monitoring module 116 monitors the actual computational parameters 307 (e.g., resource and/or data sources) utilized by the software code during execution. By analyzing CPU, memory, storage, and network usage, the monitoring module 116 provides real-time insights into system performance and workload distribution and generate execution logs 142. Additionally, the monitoring module 116 generates execution logs 142 containing information regarding interactions with external or internal data sources, capturing critical metadata related to data access patterns and dependencies. The collected execution log 142 serves as a detailed record of runtime behavior, enabling debugging, performance optimization, and compliance verification.

The passive real-time analysis engine 118 continuously monitors the code execution in the pre-configured virtual environment 303 without interfering with its operation to detect deviations from predicted computational parameters 309 (e.g., utilization of computational resources and data sources). This analysis compares actual computational parameters 307 (e.g., resource consumption—such as CPU, memory, disk I/O, and network bandwidth) against expected or pre-modeled benchmarks (e.g., predicted computational parameters 309) to identify anomalies, inefficiencies, or unexpected behaviors.

The prepared article analysis MLM 130 analyzes the scientific or technical document 102 to predict computational parameters 309 utilized when the software code 104 is executed. The predicted computational parameters 309 for the scientific or technical document 102 are determined based on a known computational model of a similar scientific or technical document from the previously analyzed articles database (not pictured). This process enables the system to infer computational methods that are likely relevant to the scientific or technical document 102, even if they are not explicitly stated. By leveraging known computational models for previously analyzed documents, the prepared article analysis MLM 130 identifies patterns and relationships between scientific concepts and computational models, improving the accuracy and relevance of model predictions.

In some aspects, the prepared article analysis MLM 130 may generate a similarity score between the scientific or technical document 102 and the similar scientific or technical document from the previously analyzed articles database 146 using an optional benchmarking module (not pictured) to calibrate the prediction. For example, if the scientific or technical document is very similar to another scientific or technical document identified from the previously analyzed articles dataset, then the similarity criteria will be high and the predicted computational parameter 309 generated by the prepared article analysis MLM 130 can be trusted fairly accurate. However, as another example, if the scientific or technical document is not similar to another scientific or technical document identified from the previously analyzed articles dataset, the similarity criteria will be low and the computational parameter 309 generated by the prepared article analysis MLM 130 will probably not be accurate because there is no similar known computational model for the prepared article analysis MLM 130.

At 311, if deviations are not detected between the actual computational parameters 307 and the predict computational parameters 309, then the monitoring module 116 continues to monitor the actual computational parameters 307. At 311, if deviations are detected, such as excessive resource usage, bottlenecks, or underutilization, the system halts execution of the software code 104 in the pre-configured virtual environment 303 and performs a performance analysis (e.g., one of or any one of a combination of static analysis, execution artifact’s analysis and/or symbolic execution) using the performance analysis engine 120. In this case, halting the software code 104 in the pre-configured virtual environment 303 rather than completely terminating the software code 104. By implementing this type of halting, the system ensures flexibility in the process, enabling a smooth continuation without requiring an entire restart.

The performance analysis engine 120 may perform a performance analysis of the execution log 142 and temporary files created during code execution. The performance analysis may include one of or a combination of an active static analysis, execution artifacts analysis and/or symbolic execution. The performance analysis involves systematically examining these artifacts for indicators of suspicious or malicious behavior to generate active static risks 315. This process includes scanning execution logs for anomalies such as unexpected system calls, unauthorized data access patterns, or deviations from normal execution sequences. Additionally, analyzing temporary files can help detect unauthorized modifications, unexpected file creation, or suspicious data exfiltration attempts. By leveraging heuristic analysis, rule-based detection, or machine learning models, the system can identify potential active static risks 315, such as malware injection, privilege escalation, or unauthorized resource consumption.

In some aspects, the malware analysis module 122 may be configured to also perform malware analysis on execution logs 142 and temporary files generated during code execution in the pre-configured virtual environment 303. The malware analysis is a crucial technique for detecting and understanding malicious behavior. By systematically examining execution logs 142, the malware analysis module 122 can trace function calls, system interactions, and behavioral anomalies indicative of malware activity. Additionally, analyzing a plurality of temporary files (e.g., cache files, runtime artifacts, and dynamically created executables) can reveal evidence of code injection, privilege escalation, or data exfiltration. Automated tools and heuristics further enhance this analysis by flagging deviations from normal execution patterns, enabling early threat detection and mitigation.

At 317, the system may determine whether the code 104 is safe to continue by evaluating both the passive real-time risks 313 generated by the passive real-time analysis engine 118 and the active static risks 315 generated by the performance analysis engine 120 and/or the malware analysis module 122. As a first layer of security, the passive real-time analysis engine 118 continuously monitors execution behaviors, detecting anomalies, suspicious patterns, or deviations from expected runtime activities in real time. As a second layer of security, the performance analysis engine 120 and the malware analysis module 122 conduct in-depth evaluations of the code’s structure, identifying potential threats based on known malware signatures, heuristic patterns, or code vulnerabilities while the code execution is halted. By correlating these risk assessments, the system ensures a comprehensive security evaluation, determining whether execution should proceed, be restricted, or be terminated to mitigate potential threats. This dual-layered approach enhances security by leveraging both dynamic and static analysis to prevent malicious code execution proactively.

Based on a determination by a recommendation engine (e.g., recommendation engine 124 shown in FIG. 1) that the code 104 is not safe to continue, then the method 300 may provide a recommendation 319 to the user. The recommendation may be to stop execution of the software code 104 or alert a security officer.

Based on a determination by the recommendation engine that the code 104 is safe to continue, then the method 300 may determine that no malware or suspicious activity has been found. In some examples, this may mean that the code execution is safe, but resource utilization may be below the predicted computational parameters 309. In this case, the optional virtual environment module 114 may adjust the virtual environmental configurations accordingly and re-execute the code 104 in the pre-configured virtual environment 303.

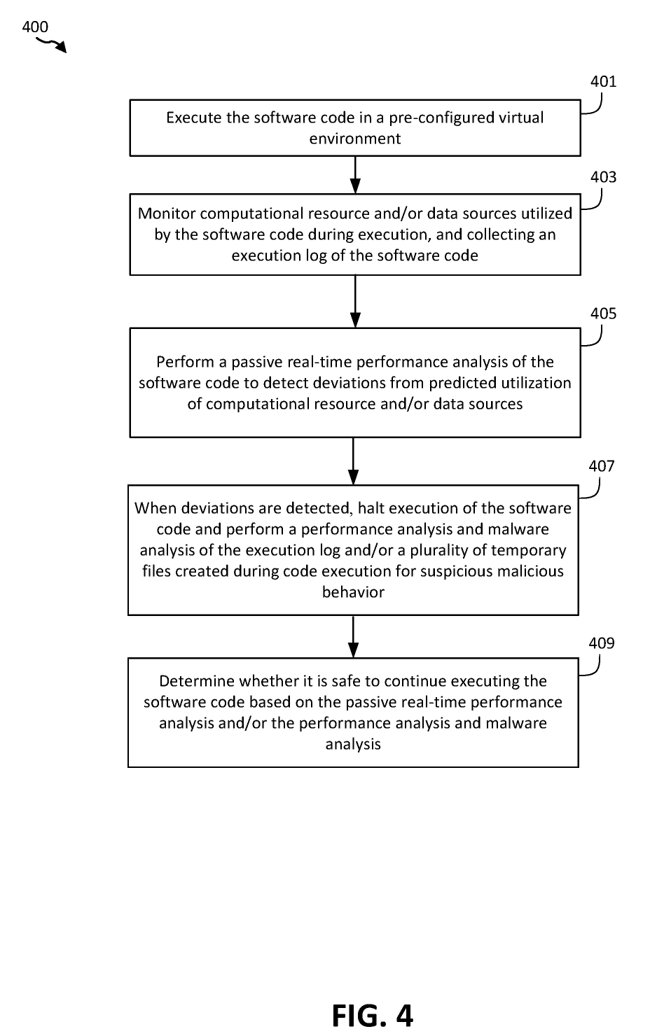

FIG. 4 is an example method for preparing machine learning models to analyze safety of software code associated with scientific or technical documents before execution of the software code according to an aspect of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method of analyzing the safety of software code associated with scientific or technical documents before execution of the software code according to aspects of the present disclosure.

At 401, the method 400 may include executing the software code in the pre-configured virtual environment.

In some aspects, pre-configuring the virtual environment comprises: analyzing the software code and/or associated scientific or technical document using one or more prepared machine learning models (MLM) to predict computational resources and/or data sources to be utilized during execution of the software code; andconfiguring the virtual environment before execution of the software code based on the predicted computational resources and/or data sources.

In some aspects, the computational resources may include one or more of: processor utilization, memory utilization, number of computational iterations, duration of the computation, and/or network utilization

At 403, the method 400 may include monitoring computational resource and/or data sources utilized by the software code during execution and collecting an execution log of the software code.

At 405, the method 400 may include performing a passive real-time performance analysis of the software code to detect deviations from predicted utilization of computational resource and/or data sources.

In some aspects, the deviations include at least one of: accessing external redate sources, accessing forbidden system resources, changing OS kernel parameters, and/or utilizing more or less computational or network resources than predicted.

At 407, the method 400 may include, when deviations are detected, halting execution of the software code and performing a performance analysis and malware analysis of the execution log and/or a plurality of temporary files created during code execution for suspicious malicious behavior.

In some aspects, the performance analysis comprises any one of an active static analysis, execution artifact analysis, and/or symbolic execution. Active static analysis enables early detection of potential performance issues by simulating execution paths without running the code, allowing developers to identify inefficiencies or bottlenecks before deployment. Execution artifact analysis examines runtime-generated data, such as logs and memory traces, to provide real-world insights into system behavior, helping to diagnose performance degradation, unexpected resource consumption, or security risks. Symbolic execution enhances performance analysis by exploring multiple execution paths through mathematical modeling, identifying edge cases that could lead to inefficiencies or failures. By incorporating one or more of these approaches, the system ensures a comprehensive evaluation of software performance, leading to optimized execution, reduced runtime issues, and improved overall reliability.

Active static analysis is a hybrid approach to code analysis that combines traditional static analysis techniques with controlled execution or simulation of code behavior. Unlike purely static analysis, which examines code without running it, active static analysis may involve symbolic execution, constraint solving, or model checking to explore different execution paths. This allows it to detect complex security vulnerabilities, logic errors, or potential runtime issues more effectively while still maintaining the benefits of static analysis, such as scalability and early detection in the development cycle.

Execution artifact analysis is the process of examining byproducts generated during a program's execution, such as logs, memory dumps, network traces, or runtime traces, to gain insights into its behavior, performance, and security. This type of analysis helps identify anomalies, detect security threats, debug issues, and optimize performance by evaluating how a system operates in real-world conditions. By analyzing execution artifacts, developers and security professionals can uncover hidden vulnerabilities, unexpected behaviors, or inefficiencies that may not be apparent through static or dynamic code analysis alone.

Symbolic execution is a program analysis technique that explores multiple execution paths by treating inputs as symbolic variables rather than concrete values. Instead of running the code with specific inputs, it systematically analyzes all possible execution branches by solving mathematical constraints on symbolic variables. This allows it to detect potential bugs, security vulnerabilities, and unreachable code by identifying conditions that could lead to errors, such as buffer overflows or null pointer dereferences.

In some aspects, the method 400 may include performing the active static performance analysis using a prepared MLM trained on a plurality of scientific or technical documents to understand contents of the temporary files.

In some aspects, the method 400 may includeperforming the malware analysis using a prepared MLM trained on a plurality of known malicious behavior patterns and/or malware signatures.

At 409, the method 400 may include determining whether it is safe to continue executing the software code based on the passive real-time performance analysis and/or the performance analysis and malware analysis.

In some aspects, the method 400 may include, based on a determination that the software code is safe, reconfiguring the virtual environment based on detected deviations in utilized computational resources and/or data sources; and continuing executing the software code in the re-configured virtual environment.

In some aspects, the method 400 may include preparing a first MLM to analyze the software code to predict computational parameters based on the software code by: (1) providing, to the first MLM, an analysis training dataset comprising at least: (a) a code training dataset comprising at least source code and metadata corresponding to features for the source code to extract patterns that predict computational parameters, (b) a computational parameter training dataset comprising at least data requirement information and execution configuration information to provide ground truth labels for computational parameters required for execution, (c) a code-document interaction training dataset comprising at least annotations, mapping rules, and execution example logs to provide additional context about how the software code was executed, and (d) ground truth labels for the code training dataset, the computational parameter training dataset, and the code-document interaction training dataset to serve as a target output for the first MLM; and(2) preparing the first MLM using the analysis training dataset.

In some aspects, the method 400 may include: preparing a second MLM to analyze the scientific or technical document to predict computational parameters based on the scientific or technical document and known computational parameters of a similar scientific or technical document by: (1) providing, to the second MLM, a document analysis training dataset comprising at least: (a) a training documents dataset comprising at least text of training documents and metadata to enable similarity analysis and prediction, wherein the training documents dataset is labeled and annotated to identify a subject matter to group documents, (b) a code training dataset comprising at least source code associated with the training documents and metadata corresponding to features of source code to capture features from code associated with the training documents to provide execution context, (c) a computational parameter training dataset comprising at least execution settings and execution logs to provide ground truth labels for computational parameters required for execution, (d) a similarity training dataset comprising at least document similarity pairs, code similarity pairs, and cross-mapping data to establish relationships between documents based on similarity and associated execution parameters, (e) ground truth labels for the training documents dataset, the code training dataset, the computational parameter training dataset, and the similarity training dataset to serve as a target output for the second MLM; and (2) preparing the second MLM using the document analysis training dataset.

FIG. 5 presents an example of a general-purpose computer system on which aspects of the present disclosure can be implemented.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for analyzing safety of software code associated with scientific or technical documents during execution of the software code in a pre-configured virtual environment, the method comprising:
executing the software code in the pre-configured virtual environment;
monitoring computational resources and/or data sources utilized by the software code during execution, and collecting an execution log of the software code;
performing a passive real-time performance analysis of the software code to detect deviations from predicted utilization of computational resource and/or data sources;
when deviations are detected, halting execution of the software code and performing a performance analysis and malware analysis of the execution log and/or a plurality of temporary files created during code execution for suspicious malicious behavior; and
determining whether it is safe to continue executing the software code based on the passive real-time performance analysis and/or the performance analysis and malware analysis.

2. The method of claim 1, further comprising:
setting up the pre-configured virtual environment by analyzing the software code and/or associated scientific or technical document using one or more prepared machine learning models (MLM) to predict computational resources and/or data sources to be utilized during execution of the software code, and configuring the virtual environment before execution of the software code based on the predicted utilization of the computational resources and/or data sources.

3. The method of claim 1, further comprising:
performing the performance analysis using a prepared MLM trained on a plurality of scientific or technical documents to understand contents of the plurality of temporary files.

4. The method of claim 1, further comprising:
performing the malware analysis using a prepared MLM trained on a plurality of known malicious behavior patterns and/or malware signatures.

5. The method of claim 1, further comprising:
based on a determination that the software code is safe, reconfiguring the pre-configured virtual environment based on detected deviations in utilized computational resources and/or data sources; and
continuing executing the software code in the re-configured virtual environment.

6. The method of claim 1, wherein the computational resources comprises one or more of: processor utilization, memory utilization, number of computational iterations, duration of the computation, and/or network utilization.

7. The method of claim 1, wherein the deviations include at least one of: accessing external redate sources, accessing forbidden system resources, changing OS kernel parameters, and/or utilizing more or less computational or network resources than predicted.

8. The method of claim 2, further comprising: preparing a first MLM to analyze the software code to predict computational parameters based on the software code by:
(1) providing, to the first MLM, an analysis training dataset comprising at least:
(a) a code training dataset comprising at least source code and metadata corresponding to features for the source code to extract patterns that predict computational parameters,
(b) a computational parameter training dataset comprising at least data requirement information and execution configuration information to provide ground truth labels for computational parameters required for execution,
(c) a code-document interaction training dataset comprising at least annotations, mapping rules, and execution example logs to provide additional context about how the software code was executed, and
(d) ground truth labels for the code training dataset, the computational parameter training dataset, and the code-document interaction training dataset to serve as a target output for the first MLM; and
(2) preparing the first MLM using the analysis training dataset.

9. The method of claim 2, further comprising: preparing a second MLM to analyze the scientific or technical documents to predict computational parameters based on the scientific or technical documents and known computational parameters of a similar scientific or technical document by:
(1) providing, to the second MLM, a document analysis training dataset comprising at least:
(a) a training documents dataset comprising at least text of training documents and metadata to enable similarity analysis and prediction, wherein the training documents dataset is labeled and annotated to identify a subject matter to group documents,
(b) a code training dataset comprising at least source code associated with the training documents and metadata corresponding to features of source code to capture features from code associated with the training documents to provide execution context,
(c) a computational parameter training dataset comprising at least execution settings and execution logs to provide ground truth labels for computational parameters required for execution,
(d) a similarity training dataset comprising at least document similarity pairs, code similarity pairs, and cross-mapping data to establish relationships between documents based on similarity and associated execution parameters,
(e) ground truth labels for the training documents dataset, the code training dataset, the computational parameter training dataset, and the similarity training dataset to serve as a target output for the second MLM; and
(2) preparing the second MLM using the document analysis training dataset.

10. The method of claim 1, wherein the performance analysis comprises any one of an active static analysis, execution artifact analysis, and/or symbolic execution.

11. A system for analyzing safety of software code associated with scientific or technical documents during execution of the software code in a pre-configured virtual environment, comprising:
at least one memory; and
at least one hardware processor coupled with the at least one memory and configured, individually or in combination, to:
execute the software code in the pre-configured virtual environment;
monitor computational resources and/or data sources utilized by the software code during execution, and collecting an execution log of the software code;
performing a passive real-time performance analysis of the software code to detect deviations from predicted utilization of computational resource and/or data sources; and
when deviations are detected, halt execution of the software code and perform a performance analysis and malware analysis of the execution log and/or a plurality of temporary files created during code execution for suspicious malicious behavior; and
determine whether it is safe to continue executing the software code based on the passive real-time performance analysis and/or the performance analysis and malware analysis.

12. The system of claim 11, wherein the at least one hardware processor is coupled with the at least one memory and configured, individually or in combination, to:
set up the pre-configured virtual environment by:
analyzing the software code and/or associated scientific or technical document using one or more prepared machine learning models (MLM) to predict computational resources and/or data sources to be utilized during execution of the software code, and
configuring the pre-configured virtual environment before execution of the software code based on the predicted utilization of the computational resources and/or data sources.

13. The system of claim 11, wherein the least one hardware processor is coupled with the at least one memory and configured, individually or in combination, to:
perform the performance analysis using a prepared MLM trained on a plurality of scientific or technical documents to understand contents of the plurality of temporary files.

14. The system of claim 11, wherein the least one hardware processor is coupled with the at least one memory and configured, individually or in combination, to:
performing the malware analysis using a prepared MLM trained on a plurality of known malicious behavior patterns and/or malware signatures.

15. The system of claim 11, wherein the least one hardware processor is coupled with the at least one memory and configured, individually or in combination, to:
based on a determination that the software code is safe, reconfigure the virtual environment based on detected deviations in utilized computational resources and/or data sources; and
continue executing the software code in the re-configured virtual environment.

16. The system of claim 11, wherein computational resources include one or more of: processor utilization, memory utilization, number of computational iterations, duration of the computation, and/or network utilization.

17. The system of claim 11, wherein the deviations include at least one of: accessing external redate sources, accessing forbidden system resources, changing OS kernel parameters, and/or utilizing more or less computational or network resources than predicted.

18. The system of claim 12, wherein the least one hardware processor is coupled with the at least one memory and configured, individually or in combination, to: prepare a first MLM to analyze the software code to predict computational parameters based on the software code by:
(1) providing, to the first MLM, an analysis training dataset comprising at least:
(a) a code training dataset comprising at least source code and metadata corresponding to features for the source code to extract patterns that predict computational parameters,
(b) a computational parameter training dataset comprising at least data requirement information and execution configuration information to provide ground truth labels for computational parameters required for execution,
(c) a code-document interaction training dataset comprising at least annotations, mapping rules, and execution example logs to provide additional context about how the software code was executed, and
(d) ground truth labels for the code training dataset, the computational parameter training dataset, and the code-document interaction training dataset to serve as a target output for the first MLM; and
(2) preparing the first MLM using the analysis training dataset.

19. The system of claim 11, wherein the performance analysis comprises any one of an active static analysis, execution artifact analysis, and/or symbolic execution

20. A non-transitory computer readable medium storing thereon computer executable instructions for analyzing safety of software code associated with scientific or technical documents during execution of the software code in a pre-configured virtual environment, including instructions for:
executing the software code in the pre-configured virtual environment;
monitoring computational resources and/or data sources utilized by the software code during execution, and collecting an execution log of the software code;
performing a passive real-time performance analysis of the software code to detect deviations from predicted utilization of computational resource and/or data sources; and
when deviations are detected, halting execution of the software code and performing the performance analysis and malware analysis of the execution log and/or a plurality of temporary files created during code execution for suspicious malicious behavior; and
determining whether it is safe to continue executing the software code based on the passive real-time performance analysis and/or the performance analysis and malware analysis.
